(19) United States
(12) Patent Application Publication
(10) Pub. No.: US 2016/0054883 A1
(43) Pub. Date: Feb. 25, 2016

(54) METHOD AND DEVICE FOR POSITIONING CURSOR

(71) Applicant: Xiaomi Inc., Beijing (CN)

(72) Inventors: Yi GAO, Beijing (CN); Hongqiang WANG, Beijing (CN); Hai LONG, Beijing (CN)

(73) Assignee: Xiaomi Inc.

(21) Appl. No.: 14/727,274

(22) Filed: Jun. 1, 2015

Related U.S. Application Data
(63) Continuation of application No. PCT/CN2015/074943, filed on Mar. 24, 2015.

(30) Foreign Application Priority Data
Aug. 21, 2014 (CN) 201410416076.2

(51) Int. Cl. G06F 3/0488; G06F 3/041; G06F 3/033

(52) U.S. Cl. CPC G06F 3/0488; G06F 3/033; G06F 3/0416

(57) ABSTRACT

A method for positioning a cursor in an input box on a display interface of a touch screen includes receiving a first touch operation associated with the input box; determining target content in the input box, an operating distance of the first touch operation, and an operating direction of the first touch operation; moving the target content by a distance corresponding to the operating distance along the operating direction to form a blank space between a side of the input box and a side edge of the target content; receiving a second touch operation associated with the blank space; and positioning the cursor at a cursor position in the blank space.

### CROSS-REFERENCE TO RELATED APPLICATIONS

This application is a continuation of International Application No. PCT/CN2015/074943, filed Mar. 24, 2015, which is based upon and claims priority to Chinese Patent Application No. 201410416076.2, filed Aug. 21, 2014, the entire contents of both of which are incorporated herein by reference.

### TECHNICAL FIELD

The present disclosure relates to electronic devices and, more particularly, to a method and device for positioning a cursor.

### BACKGROUND

Sometimes, when a user of an apparatus having a touch screen needs to input content, such as characters or pictures, in an input box on the touch screen, the left edge of the input content may be too close to the left side of the input box. Moreover, when a full line of content is inputted into the input box, the right edge of the input content may be too close to the right side of the input box.

### SUMMARY

In accordance with the present disclosure, there is provided a method for positioning a cursor in an input box on a display interface of a touch screen. The method includes receiving a first touch operation associated with the input box; determining target content in the input box, an operating distance of the first touch operation, and an operating direction of the first touch operation; moving the target content by a distance corresponding to the operating distance along the operating direction to form a blank space between a side of the input box and a side edge of the target content; receiving a second touch operation associated with the blank space; and positioning the cursor at a cursor position in the blank space.

In accordance with the present disclosure, there is also provided a device for positioning a cursor in an input box on a display interface of a touch screen. The device includes a processor and a non-transitory computer-readable storage medium storing instructions. The instructions, when executed by the processor, cause the processor to receive a first touch operation associated with the input box; to determine target content in the input box, an operating distance of the first touch operation, and an operating direction of the first touch operation; to move the target content by a distance corresponding to the operating distance along the operating direction to form a blank space between a side of the input box and a side edge of the target content; to receive a second touch operation associated with the blank space; and to position the cursor at a cursor position in the blank space.

In accordance with the present disclosure, there is also provided a non-transitory computer-readable storage medium storing instructions. The instructions, when executed by a processor in an apparatus having a touch screen, cause the apparatus to receive a first touch operation associated with an input box on a display interface of the touch screen; to determine target content in the input box, an operating distance of the first touch operation, and an operating direction of the first touch operation; to move the target content by a distance corresponding to the operating distance along the operating direction to form a blank space between a side of the input box and a side edge of the target content; to receive a second touch operation associated with the blank space; and to position the cursor at a cursor position in the blank space.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for positioning a cursor according to an exemplary embodiment.

FIG. 2 is a flow chart of a method for positioning a cursor according to another exemplary embodiment.

FIG. 3 is a flow chart of a method for positioning a cursor according to another exemplary embodiment.

FIG. 4A is a flow chart of a method for positioning a cursor according to another exemplary embodiment.

FIG. 4B is a scene view of a method for positioning a cursor according to an exemplary embodiment.

FIG. 5 is a block diagram of a device for positioning a cursor according to an exemplary embodiment.

FIG. 6 is a block diagram of a device for positioning a cursor according to another exemplary embodiment.

FIG. 7A is a block diagram of a device for positioning a cursor according to another exemplary embodiment.

FIG. 7B is a block diagram of a device for positioning a cursor according to another exemplary embodiment.

FIG. 8A is a block diagram of a device for positioning a cursor according to another exemplary embodiment.

FIG. 8B is a block diagram of a device for positioning a cursor according to another exemplary embodiment.

FIG. 9 is a block diagram of a device adapted for positioning a cursor according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

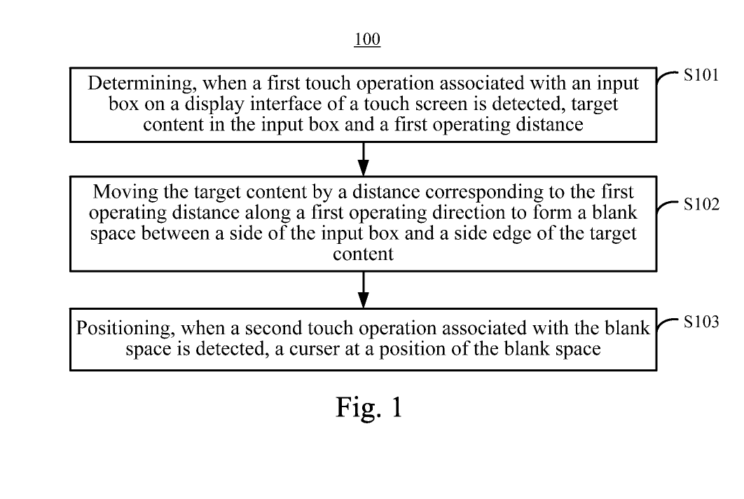

FIG. 1 is a flow chart of an exemplary method 100 for positioning a cursor in an input box consistent with embodiments of the present disclosure. The method 100 can be implemented in an apparatus having a touch screen, such as a mobile phone or a tablet.

As shown in FIG. 1, at S101, when a first touch operation associated with an input box on a display interface of the touch screen is detected, content in the input box at which the first touch operation targets (such content is also referred to as “target content”) and a first operating distance are determined. The target content may be, for example, characters, pictures, or combinations of characters and pictures. In some embodiments, a first operating direction of the first touch operation is consistent with an alignment direction of the target content. For instance, when content is entered in the input box in a transverse direction, the first operating direction of the first touch operation is a left-right direction. On the other hand, when content is entered in the input box in a vertical direction, the first operating direction of the first touch operation is an up-down direction.

In some embodiments, when the first touch operation is conducted in the input box of the touch screen, a sensor on the touch screen senses the first touch operation and sends a signal to a processor and forwards sensed information to the processor. The processor determines positions of an operation starting point and an operation ending point of the first touch operation according to the received information, and obtains the first operating distance of the first touch operation according to the determined positions.

The target content can be determined according to the position of the operation starting point or the position of the operation ending point of the first touch operation. The target content can be content in a line associated with the operation starting point or the operation ending point, or content in a range from the n^{th} line above to the n^{th} line below the line containing the operation starting point or the operation ending point, where n is a preset positive integer. In some embodiments, the target content can be determined according to the positions of the operation starting point and the operation ending point of the first touch operation. For instance, the target content may be the content between the operation starting point and the operation ending point of the first touch operation.

At S102, the target content is moved by a distance corresponding to the first operating distance along the first operating direction to form a blank space between a side of the input box and a side edge of the target content. An edge of the target content in the input box refers to a boundary of a region within which the target content is located, for example, a boundary of a region displayed when a selection operation is performed on the target content in the input box.

In some embodiments, when the first operating distance is less than a preset distance, the target content is moved by the first operating distance along the first operating direction. On the other hand, when the first operating distance is not less than the preset distance, the target content is moved by the preset distance along the first operating direction. In some embodiments, the preset distance equals a product of a width of the input box in the first operating direction and a preset percentage.

For example, the first touch operation is a swiping from left to right, the first operating direction is from left to right, the first operating distance is S1, the width of the input box in the left-right direction is W, and the preset percentage is 20%. When S1<W×20%, the target content is moved by S1 along the direction from left to right. When S1≧W×20%, the target content is moved by W×20% along the direction from left to right. As a result, a blank space is formed between a left side of the input box and a left edge of the target content.

As another example, the first touch operation is a swiping from right to left, the first operating direction is from right to left, the first operating distance is S1, the width of the input box in the left-right direction is W, and the preset percentage is 20%. When S1<W×20%, the target content is moved by S1 along the direction from right to left. When S1≧W×20%, the target content is moved by W×20% along the direction from right to left. As a result, a blank space is formed between a right side of the input box and a right edge of the target content.

For example, the first touch operation is a swiping from up to down, the first operating direction is from up to down, the first operating distance is S1, the width of the input box in the up-down direction is H, and the preset percentage is 20%. When S1<H×20%, the target content is moved by S1 along the direction from up to down. When S1≧H×20%, the target content is moved by H×20% along the direction from up to down. As a result, a blank space is formed between an upper side of the input box and an upper edge of the target content.

As another example, the first touch operation is a swiping from down to up, the first operating direction is from down to up, the first operating distance is S1, the width of the input box in the up-down direction is H, and the preset percentage is 20%. When S1<H×20%, the target content is moved by S1 along the direction from down to up. When S1≧H×20%, the target content is moved by H×20% along the direction from down to up. As a result, a blank space is formed between a lower side of the input box and a lower edge of the target content.

In some embodiments, the target content is determined to be content in the line containing the operation starting point of the first touch operation. In this scenario, S102 includes moving the content in the line containing the operation starting point of the first touch operation by a distance corresponding to the first operating distance along the first operating direction to form the blank space between the side of the input box and the side edge of the content in the line containing the operation starting point.

For example, the first touch operation is a swiping from left to right, the first operating direction is from left to right, the first operating distance is S1, the width of the input box in the left-right direction is W, the preset percentage is 20%, and the line containing the operation starting point of the first touch operation is the i^{th} row. When S1<W×20%, the content of the i^{th} row are moved by S1 along the direction from left to right. When S1≧W×20%, the content of the i^{th} line are moved by W×20% along the direction from left to right. As a result, a blank space is formed between a left side of the input box and a left edge of the content of the i^{th} TOW.

As another example, the first touch operation is a swiping from right to left, the first operating direction is from right to left, the first operating distance is S1, the width of the input box in the left-right direction is W, the preset percentage is 20%, and the line containing the operation starting point of the first touch operation is the i^{th} row. When S1<W×20%, the content of the i^{th} row are moved by S1 along the direction from right to left. When S1≧W×20%, the content of the i^{th} row are moved by W×20% along the direction from right to left. As a result, a blank space is formed between a right side of the input box and a right edge of the content of the i^{th} row.

For example, the first touch operation is a swiping from up to down, the first operating direction is from up to down, the first operating distance is S1, the width of the input box in the up-down direction is H, the preset percentage is 20%, and the line containing the operation starting point of the first touch operation is the j^{th} column. When S1<H×20%, the content in the j^{th} column are moved by S1 along the direction from up to down. When S1≧H×20%, the content in the j^{th} column are moved by H×20% along the direction from up to down. As a result, a blank space is formed between an upper side of the input box and an upper edge of the content in j^{th} column.

As another example, the first touch operation is a swiping from down to up, the first operating direction is from down to up, the first operating distance is S1, the width of the input box in the up-down direction is H, the preset percentage is 20%, and the line of the operation starting point of the first touch operation is the j^{th} column. When S1<H×20%, the content in the j^{th} column are moved by S1 along the direction from down to up. When S1≧H×20%, the content in the j^{th} column are moved by H×20% along the direction from down to up. As a result, a blank space is formed between a lower side of the input box and a lower edge of the content in the j^{th} column.

In some embodiments, content in a range from the n^{th} line above to the n^{th} line below the line containing the operation starting point of the first touch operation may be determined as the target content, where n is a preset positive integer. In this scenario, at S102, the content in these (2n+1) lines are entirely moved by a distance corresponding to the first operating distance along the first operating direction.

At S103, when a second touch operation associated with the blank space is detected, the cursor is placed at a position in the blank space (such position is also referred to as a “cursor position”). The cursor position may be any position in the blank space or an operating position of the second touch operation in the blank space.

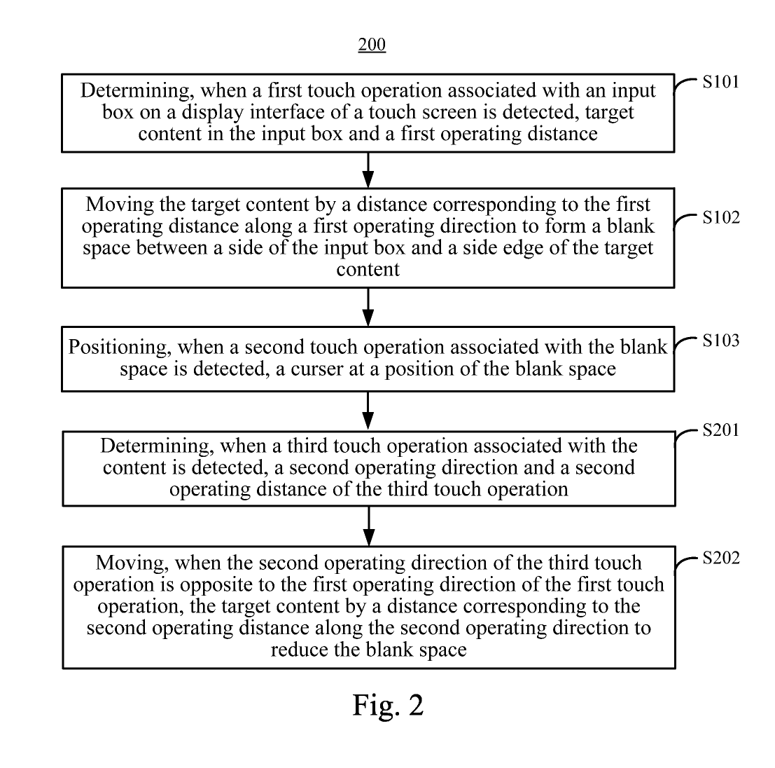

FIG. 2 is a flow chart of another exemplary method 200 for positioning a cursor consistent with embodiments of the present disclosure. The method 200 can be implemented in an apparatus having a touch screen, such as a mobile phone or a tablet. The method 200 is similar to the method 100, except that the method 200 further includes S201 and S202 described below.

As shown in FIG. 2, at S201, when a third touch operation associated with the target content is detected, a second operating direction and a second operating distance of the third touch operation are determined. In some embodiments, the second operating direction and the second operating distance of the third touch operation can be determined in a manner similar to that for determining the first operating direction and the first operating distance described above, and thus are not repeated here.

At S202, when the second operating direction of the third touch operation is opposite to the first operating direction of the first touch operation, the target content is moved by a distance corresponding to the second operating distance along the second operating direction to reduce the blank space. In some embodiments, when the second operating distance is less than a distance (length) of the blank space, the target content is moved by the second operating distance along the second operating direction. When the second operating distance is not less than the distance of the blank space, the target content is moved by the distance of the blank space along the second operating direction.

For example, the first touch operation is a swiping from left to right, the third touch operation is a swiping from right to left, the distance of the blank space between the left side of the input box and the left edge of the target content is D1, and the second operating distance of the third touch operation is S2. When S2<D1, the target content is moved by S2 along the direction from right to left. When S2≧D1, the target content is moved by D1 along the direction from right to left.

As another example, the first touch operation is a swiping from right to left, the third touch operation is a swiping from left to right, the distance of the blank space between the right side of the input box and the right edge of the target content is D1, and the second operating distance of the third touch operation is S2. When S2<D1, the target content is moved by S2 along the direction from left to right. When S2≧D1, the target content is moved by D1 along the direction from left to right.

As another example, the first touch operation is a swiping from up to down, the third touch operation is a swiping from down to up, the distance of the blank space between the upper side of the input box and the upper edge of the target content is D1, and the second operating distance of the third touch operation is S2. When S2<D1, the target content is moved by S2 along the direction from down to up. When S2≧D1, the content is moved by D1 along the direction from down to up.

As another example, the first touch operation is a swiping from down to up, the third touch operation is a swiping from up to down, the distance of the blank space between the lower side of the input box and the lower edge of the target content is D1, and the second operating distance of the third touch operation is S2. When S2<D1, the target content is moved by S2 along the direction from up to down. When S2≧D1, the target content is moved by D1 along the direction from up to down.

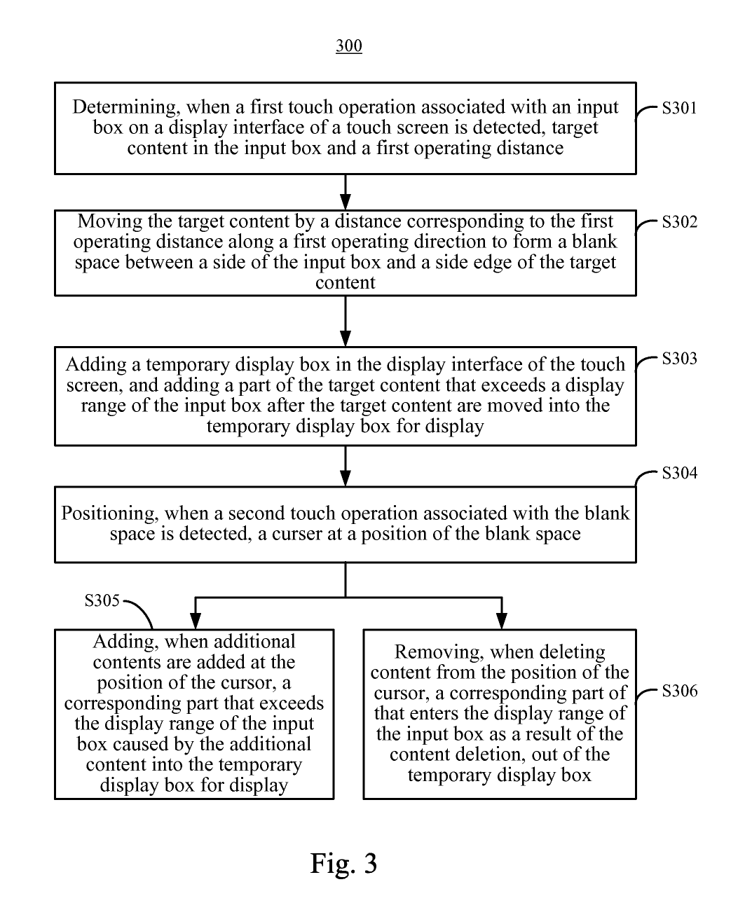

FIG. 3 is a flow chart of another exemplary method 300 for positioning a cursor consistent with embodiments of the present disclosure. The method 300 can be implemented in an apparatus having a touch screen, such as a mobile phone or a tablet. S301 and S302 in the method 300 are similar to S101 and S102 in the method 100, and thus detailed descriptions thereof are omitted here.

As shown in FIG. 3, at S303, a temporary display box is added in the display interface of the touch screen, and a part of the target content that exceeds a display range of the input box after the target content is moved is added into the temporary display box for display. In some embodiments, the temporary display box may be a bubble.

For example, in the case that the first touch operation is an operation from left to right, a bubble is added at the end of the target content. The part of the target content that exceeds the right side edge of the input box after the target content is moved is added into the bubble.

Moreover, when the space between the side of the input box and the side edge of the target content in the input box is reduced, a corresponding part of content in the temporary display box, that would enter the display range of the input box, is removed out of the temporary display box.

In some embodiments, instead of being placed in the temporary display box, the corresponding part that exceeds the display range of the input box can be moved to a next line in the input box.

S304 of the method 300 is similar to S103 of the method 100, and thus detailed descriptions thereof are omitted here.

At S305, when additional content is entered at the position of the cursor, a corresponding part of the target content, that exceeds the display range of the input box as a result of adding the additional content, is moved into the temporary display box for display. In some embodiments, the temporary display box may be a bubble.

In some embodiments, instead of being placed in the temporary display box, the corresponding part that exceeds the display range of the input box can be moved to the next line in the input box.

At S306, when content is deleted from the position of the cursor, a corresponding part of the content in the temporary display box, that could enter the display range of the input box as a result of the content deletion, is removed out of the temporary display box.

In some embodiments, instead of the approach described in the paragraph immediately above, when content is deleted from the position of the cursor, a corresponding part of the content in the next line in the input box, that could move into the line of the cursor as a result of the content deletion is removed, out of the next line.

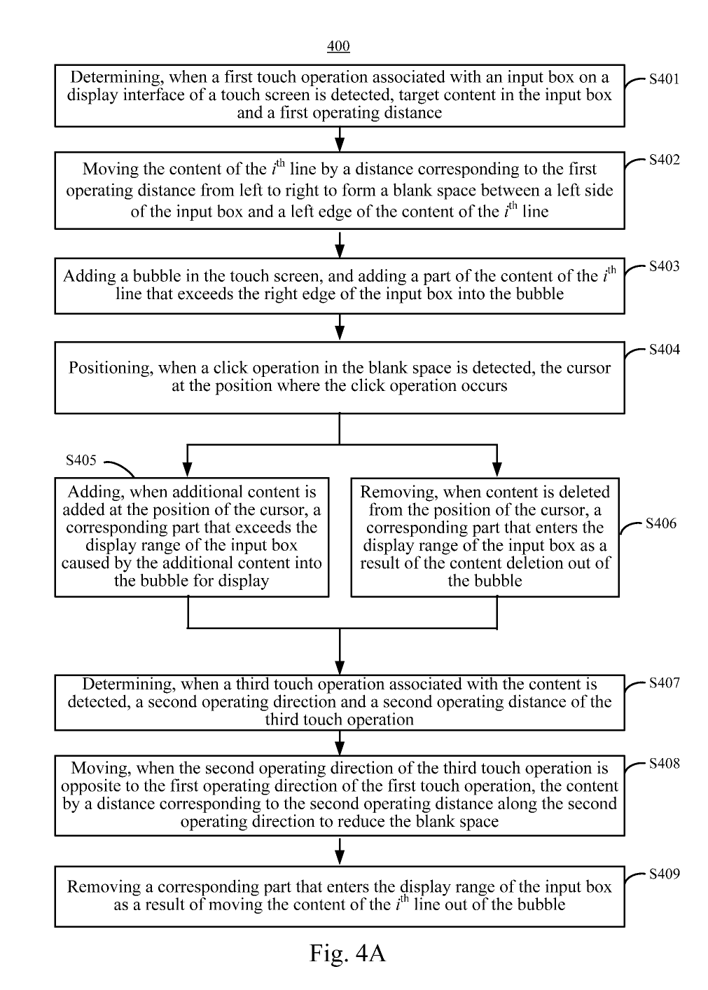

An exemplary application method 400 consistent with embodiments of the present disclosure is described below in connection with FIGS. 4A and 4B. In this example, an input box is displayed on a touch screen of a terminal device, character content is included in the input box, and a user needs to position a cursor between the left side of the input box and the beginning of the content in the i^{th} line in the input box.

As shown in FIG. 4A, at S401, when the first touch operation associated with the input box on a display interface of the touch screen is detected, target content in the input box associated with the first touch operation and the first operating distance are determined. In some embodiments, the first operating direction of the first touch operation is consistent with an alignment direction of the target content. Here, content in the i^{th} line in the input box is determined as the target content, and the first operating direction is from left to right.

At S402, the content of the i^{th} line are moved by a distance corresponding to the first operating distance from left to right to form a blank space between a left side of the input box and a left edge of the content of the i^{th} line. In some embodiments, as described above, the distance by which the content is moved is determined according to not only the first operating distance, but also the preset distance, which may be defined by the width of the input box and the preset percentage.

For example, the first operating distance of the first touch operation is S1, the width of the input box is W, and the preset percentage is 20%. When S1<W×20%, the content of the i^{th} line is moved by S1 along the direction from left to right. When S1≧W×20%, the content of the i^{th} line is moved by W×20% along the direction from left to right.

At S403, a bubble is added in the touch screen, and a part of the content of the i^{th} line that exceeds the right edge of the input box is added into the bubble.

At S404, when a click operation in the blank space between the left side of the input box and the left edge of the content of the i^{th} line is detected, the cursor is positioned at the position where the click operation occurs (such position is also referred to as “click position”).

FIG. 4B shows a scene view consistent with embodiments of the present disclosure. As shown in FIG. 4B, the distance from the left side of the input box to the left edge of the content of the i^{th} line is increased, and the cursor is positioned between the beginning of the content and the input box, i.e., between the left side of the input box and the left edge of the content of the i^{th} line. Further, a bubble is added at the end of the content of the i^{th} line. Characters in the content exceeding the right side of the input box are added into the bubble.

Consistent with the present disclosure, after the cursor is positioned at the click position, the user may enter additional content at the position of the cursor or delete content from the position of the cursor. These two scenarios are described below in S405 and S406.

At S405, when additional content is added at the position of the cursor, a corresponding part of the target content, that exceeds a display range of the input box as a result of adding the additional content, is added into the bubble for display.

At S406, when content is deleted from the position of the cursor, a corresponding part of the content in the bubble, that enters the display range of the input box as a result of the content deletion, is removed out of the bubble.

Regardless of whether additional content is added at or content is deleted from the position of the cursor, at S407, when a third touch operation associated with the content is detected, a second operating direction and a second operating distance of the third touch operation are determined. For example, the second operating direction of the third touch operation is from right to left.

At S408, when the second operating direction of the third touch operation is opposite to the first operating direction of the first touch operation, the content is moved by a distance corresponding to the second operating distance along the second operating direction to reduce the blank space.

For example, the blank space formed between the left side of the input box and the left edge of the content of the i^{th} line is D1, and the second operating distance of the third touch operation is S2. When S2<D1, the content of the i^{th} line is moved by S2 along the direction from right to left. When S2≧D1, the content of the i^{th} line is moved by D1 along the direction from right to left.

At S409, a corresponding part of the content in the bubble, that enters the display range of the input box as a result of moving the content of the i^{th} line, is removed out of the bubble.

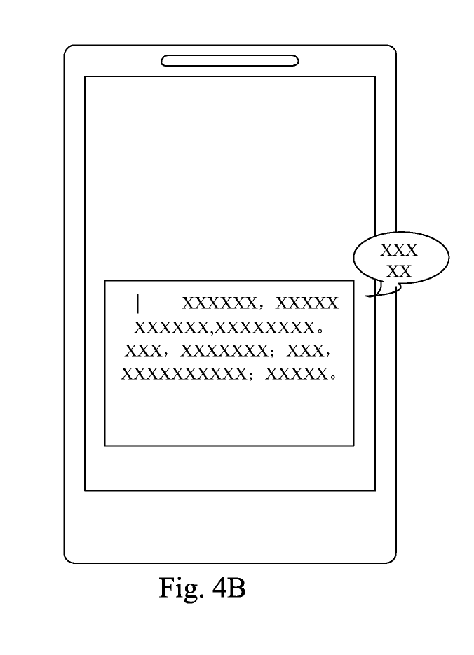

FIG. 5 illustrates an exemplary device 500 for positioning a cursor consistent with embodiments of the present disclosure. The device 500 can be implemented in an apparatus having a touch screen. As shown in FIG. 5, the device 500 includes a first detection module 51, a first moving module 52, and a positioning module 53.

The first detection module 51 is configured to, when a first touch operation associated with an input box on a display interface of the touch screen is detected, determine target content in the input box at which the first touch operation targets and a first operating distance. In some embodiments, a first operating direction of the first touch operation is consistent with an alignment direction of the target content. The first moving module 52 is configured to move the target content by a distance corresponding to the first operating distance along the first operating direction to form a blank space between a side of the input box and a side edge of the content. The positioning module 53 is configured to, when a second touch operation associated with the blank space is detected, position the cursor at the cursor position.

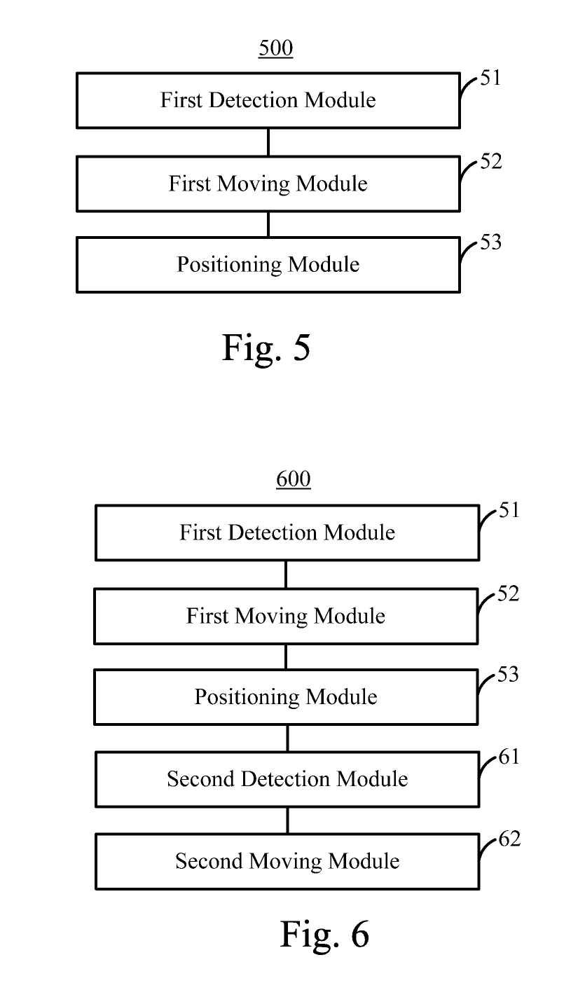

FIG. 6 illustrates another exemplary device 600 for positioning a cursor consistent with embodiments of the present disclosure. The device 600 is similar to the device 500 except that the device 600 further includes a second detection module 61 and a second moving module 62.

The second detection module 61 is configured to, when a third touch operation associated with the target content is detected, determine a second operating direction and a second operating distance of the third touch operation. The second moving module 62 is configured to, when the second operating direction is opposite to the first operating direction, move the target content by a distance corresponding to the second operating distance along the second operating direction to reduce the blank space.

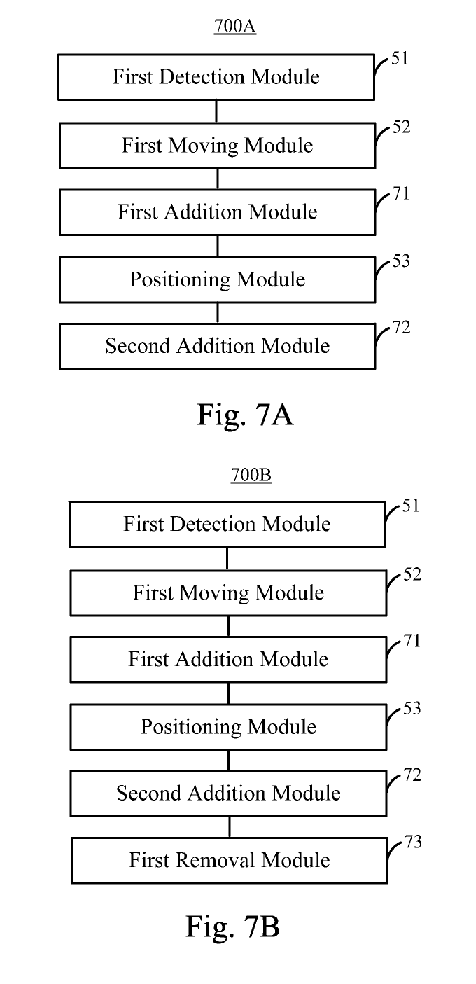

FIG. 7A illustrates another exemplary device 700A for positioning a cursor consistent with embodiments of the present disclosure. The device 700A is similar to the device 500 except that the device 700A further includes a first addition module 71 and a second addition module 72.

The first addition module 71 is configured to add a temporary display box in the display interface of the touch screen and add a part of the target content that exceeds a display range of the input box as a result of moving the target content into the temporary display box for display. The second addition module 72 is configured to, when adding additional content at the position of the cursor, add a corresponding part of the target content, that exceeds the display range of the input box as a result of adding the additional content, into the temporary display box for display.

FIG. 7B illustrates another exemplary device 700B for positioning a cursor consistent with embodiments of the present disclosure. The device 700B is similar to the device 700A except that the device 700B further includes a first removal module 73 configured to, when deleting content from the position of the cursor, remove a corresponding part of the content in the temporary display box, that enters the display range of the input box as a result of the content deletion, out of the temporary display box.

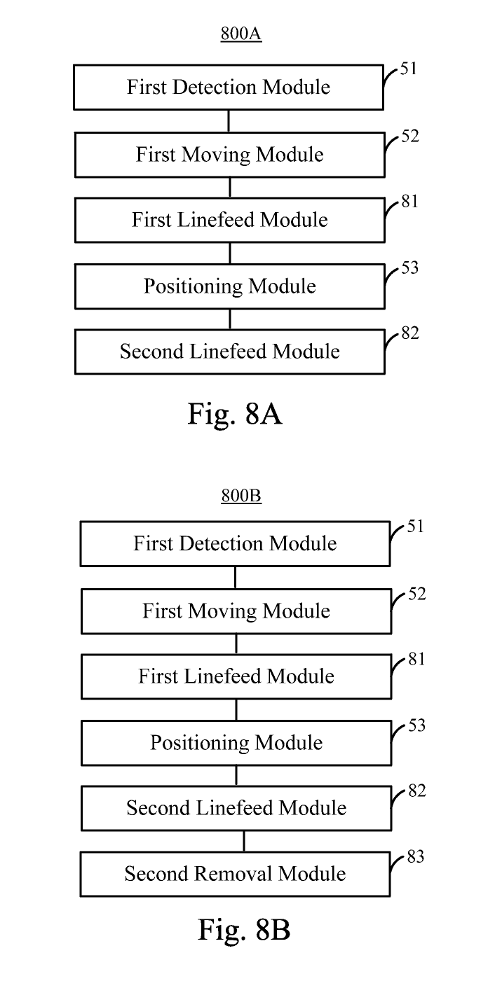

FIG. 8A illustrates another exemplary device 800A for positioning a cursor consistent with embodiments of the present disclosure. The device 800A is similar to the device 500, except that the device 800A further includes a first linefeed module 81 and a second linefeed module 82.

The first linefeed module 81 is configured to shift a part of the target content that exceeds the display range of the input box after the target content is moved to a next line in the input box. The second linefeed module 82 is configured to, when adding content at the position of the cursor, shift a corresponding part of the content in the line of the cursor, that exceeds the display range of the input box caused by the additional content, to the next line in the input box.

FIG. 8B illustrates another exemplary device 800B for positioning a cursor consistent with embodiments of the present disclosure. The device 800B is similar to the device 800A, except that the device 800B further includes a second removal module 83 configured to, when deleting content from the position of the cursor, remove a corresponding part in the next line in the input box, that moves into the line of the cursor as a result of the content deletion, out of the next line.

In some embodiments, the first moving module 52 includes a first moving submodule and a second moving submodule. The first moving submodule is configured to, when the first operating distance is less than a preset distance, move the target content by the first operating distance along the first operating direction. The second moving submodule is configured to, when the first operating distance is not less than the preset distance, move the content by the preset distance along the first operating direction. In some embodiments, the preset distance equals a product of a width of the input box in the first operating direction and a preset percentage.

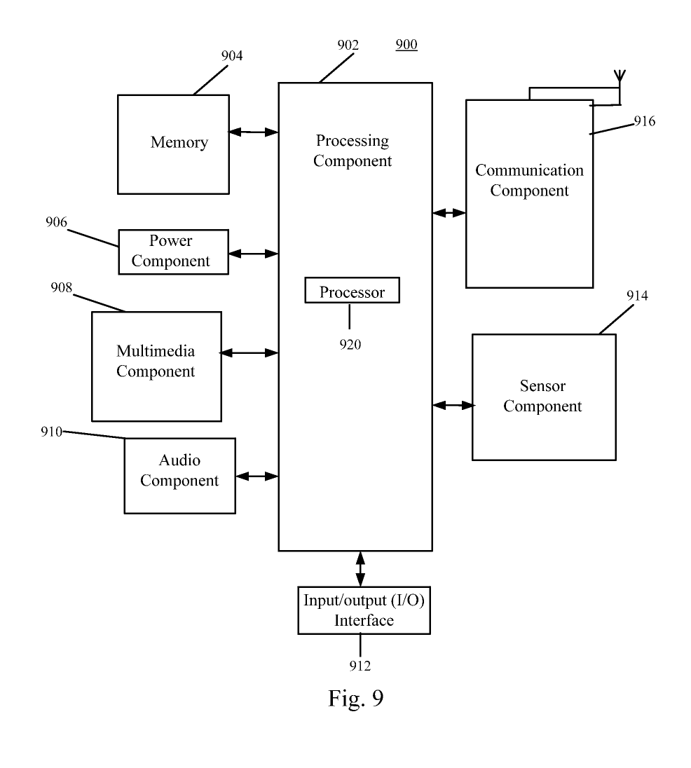

FIG. 9 is a block diagram of another exemplary device 900 for positioning cursor consistent with embodiments of the present disclosure. The device 900 can be implemented in a terminal device having a touch screen. For example, the device 900 may be a mobile phone, a computer, a digital broadcast terminal, a messaging device, a gaming console, a tablet, a medical device, exercise equipment, a personal digital assistant, or the like.

As shown in FIG. 9, the device 900 includes one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and/or the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the device 900 and other devices. The device 900 can access a wireless network based on a communication standard, such as WiFi, 2G, 3G, 4G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium, such as included in the memory 904, storing instructions that, when executed by the processor 920 in the device 900, cause the device 900 to perform methods consistent with embodiments of the present disclosure. For example, the non-transitory computer-readable storage medium may be a ROM, a RAM, a CD-ROM, a magnetic tape, a floppy disc, an optical data storage device, or the like.

Operations of devices consistent with embodiments of the present disclosure are similar to the methods described above, and thus the detailed descriptions thereof are omitted here.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for positioning a cursor in an input box on a display interface of a touch screen, the method comprising:
receiving a first touch operation associated with the input box;
determining target content in the input box, an operating distance of the first touch operation, and an operating direction of the first touch operation;
moving the target content by a distance corresponding to the operating distance along the operating direction to form a blank space between a side of the input box and a side edge of the target content;
receiving a second touch operation associated with the blank space; and
positioning the cursor at a cursor position in the blank space.

2. The method according to claim 1, wherein:
the operating distance is a first operating distance, and
the operating direction is a first operating direction;
the method further including:
receiving a third touch operation associated with the target content;
determining a second operating direction and a second operating distance of the third touch operation; and
moving, when the second operating direction is opposite to the first operating direction, the target content by a distance corresponding to the second operating distance along the second operating direction.

3. The method according to claim 1, further comprising:
adding a temporary display box in the display interface of the touch screen; and
moving, after the target content is moved, a part of the target content that exceeds a display range of the input box into the temporary display box.

4. The method according to claim 3, further comprising:
entering additional content at the cursor position; and
moving a corresponding part of the target content that exceeds the display range of the input box as a result of entering the additional content, into the temporary display box.

5. The method according to claim 3, further comprising:
deleting excessive content from the cursor position; and
removing a corresponding part of content in the temporary display box that enters the display range of the input box as a result of deleting the excessive content, out of the temporary display box.

6. The method according to claim 1, further comprising:
shifting a part of the target content that exceeds a display range of the input box after the target content is moved, to a next line in the input box.

7. The method according to claim 6, further comprising:
entering additional content at the cursor position; and
shifting a corresponding part of the target content that exceeds the display range of the input box as a result of entering the additional content, to the next line.

8. The method according to claim 6, further comprising:
deleting excessive content from the cursor position; and
removing a corresponding part of content in the next line that enters the line of the cursor as a result of deleting the excessive content, out of the next line.

9. The method according to claim 1, wherein moving the target content includes:
moving, if the operating distance is less than a preset distance, the target content by the operating distance along the operating direction; or
moving, if the operating distance is not less than the preset distance, the target content by the preset distance along the first operating direction,
wherein the preset distance equals a product of a width of the input box in the operating direction and a preset percentage.

10. A device for positioning a cursor in an input box on a display interface of a touch screen, comprising:
a processor; and
a non-transitory computer-readable storage medium storing instructions that, when executed by the processor, cause the processor to:
receive a first touch operation associated with the input box;
determine target content in the input box, an operating distance of the first touch operation, and an operating direction of the first touch operation;
move the target content by a distance corresponding to the operating distance along the operating direction to form a blank space between a side of the input box and a side edge of the target content;
receive a second touch operation associated with the blank space; and
position the cursor at a cursor position in the blank space.

11. The device according to claim 10, wherein:
the operating distance is a first operating distance, and
the operating direction is a first operating direction;
the instructions further causing the processor to:
receive a third touch operation associated with the target content;
determine a second operating direction and a second operating distance of the third touch operation; and
move, when the second operating direction is opposite to the first operating direction, the target content by a distance corresponding to the second operating distance along the second operating direction.

12. The device according to claim 10, wherein the instructions further cause the processor to:
add a temporary display box in the display interface of the touch screen; and
move, after the target content is moved, a part of the target content that exceeds a display range of the input box into the temporary display box.

13. The device according to claim 12, wherein the instructions further cause the processor to:
enter additional content at the cursor position; and
move a corresponding part of the target content that exceeds the display range of the input box as a result of entering the additional content, into the temporary display box.

14. The device according to claim 12, wherein the instructions further cause the processor to:
delete excessive content from the cursor position; and
remove a corresponding part of content in the temporary display box that enters the display range of the input box as a result of deleting the excessive content, out of the temporary display box.

15. The device according to claim 10, wherein the instructions further cause the processor to:
shift a part of the target content that exceeds a display range of the input box after the target content is moved, to a next line in the input box.

16. The device according to claim 15, wherein the instructions further cause the processor is to:
enter additional content at the cursor position; and
shift a corresponding part of the target content that exceeds the display range of the input box as a result of entering the additional content, to the next line.

17. The device according to claim 15, wherein the instructions further cause the processor is to:
delete excessive content from the cursor position; and
remove a corresponding part of content in the next line that enters the line of the cursor as a result of deleting the excessive content, out of the next line.

18. The device according to claim 10, wherein the instructions further cause the processor to:
move, if the operating distance is less than a preset distance, the target content by the operating distance along the operating direction; or
move, if the operating distance is not less than the preset distance, the target content by the preset distance along the first operating direction,
wherein the preset distance equals a product of a width of the input box in the operating direction and a preset percentage.

19. A non-transitory computer-readable storage medium storing instructions that, when executed by a processor in an apparatus having a touch screen, cause the apparatus to:
receive a first touch operation associated with an input box on a display interface of the touch screen;
determine target content in the input box, an operating distance of the first touch operation, and an operating direction of the first touch operation;
move the target content by a distance corresponding to the operating distance along the operating direction to form a blank space between a side of the input box and a side edge of the target content;
receive a second touch operation associated with the blank space; and
position the cursor at a cursor position in the blank space.
